(19) United States
(12) Patent Application Publication
(10) Pub. No.: US 2022/0156688 A1
(43) Pub. Date: May 19, 2022

(54) SHIPMENT PING RATE MANAGER

(71) Applicant: INTERNATIONAL BUSINESS MACHINES CORPORATION, Armonk, NY (US)

(72) Inventors: William J. Green, Cary, NC (US); Galen Kilpatrick Smith, Wake, NC (US); Vienna C. Polanco, Poughkeepsie, NY (US); Ryan Castronovo, Raleigh, NC (US)

(21) Appl. No.: 16/950,123

(22) Filed: Nov. 17, 2020

(51) Int. Cl. G06Q 10/08; G16Y 30/00; G06F 1/26

(52) U.S. Cl. CPC G06Q 10/0833; G16Y 10/40; G06F 1/263; G16Y 30/00

(57) ABSTRACT

A method for managing a ping rate for a shipment tracking device includes determining, a battery life for a power source of a shipment tracking device associated with a shipment between an origin location and a destination location. The method further includes determining a budget of pings for data transfer by the shipment tracking device, where a ping includes various data collected by a plurality of sensors on the shipment tracking device. The method further includes determining, based on the battery life for the power source and the budget of pings for the data transfer, a transit ping rate for an initial portion of a transit route. The method further includes responsive to receiving a first ping from the shipment tracking device with a first set of the various data, updating the transit ping rate based on the first ping with the first set of data.

### BACKGROUND

This disclosure relates generally to shipment tracking and in particular to managing a ping rate of a shipment tracking device.

Various types of battery based internet of things (IoT) enabled global positioning system (GPS) devices are utilized to track shipments during transit between an origin location and a destination location. A location of the shipment can be monitored with the IoT enabled GPS device, along with various conditions (e.g., temperature, tilt) that the shipment experiences during transit. The IoT enabled GPS device can send location data and condition data to a user in set intervals known as pings. A ping rate that defines an interval in between pings is constrained by an amount of available battery life of the IoT enabled GPS device.

### SUMMARY

Embodiments in accordance with the present invention disclose a method, computer program product and computer system for managing a ping rate for a shipment tracking device, the method, computer program product and computer system can determine a battery life for a power source of a shipment tracking device associated with a shipment. The method, computer program product and computer system can determine a budget of pings for data transfer by the shipment tracking device, wherein a ping includes various data collected by a plurality of sensors on the shipment tracking device. The method, computer program product and computer system can determine, based on the battery life for the power source and the budget of pings for the data transfer, a transit ping rate for an initial portion of a transit route. The method, computer program product and computer system can responsive to receiving a first ping from the shipment tracking device with a first set of the various data, update the transit ping rate based on the first ping with the first set of data.

### BRIEF DESCRIPTION OF THE SEVERAL VIEWS OF THE DRAWINGS

FIG. 1 is a functional block diagram illustrating a distributed data processing environment, in accordance with an embodiment of the present invention.

FIG. 2 is a flowchart depicting operational steps of a ping rate program for managing a transit ping rate of a shipment tracking device, in accordance with an embodiment of the present invention.

FIG. 3 illustrates an example of a ping rate program managing a transit ping rate and a last portion ping rate of a shipment tracking device traveling between an origin location and a destination location, in accordance with an embodiment of the present invention.

FIG. 4 is a block diagram of components of a computer system, such as the server computer of FIG. 1, in accordance with an embodiment of the present invention.

FIG. 5 depicts a cloud computing environment, in accordance with an embodiment of the present invention.

FIG. 6 depicts abstraction model layers, in accordance with an embodiment of the present invention.

### DETAILED DESCRIPTION

Embodiments of the present invention provide a ping rate program for managing a ping rate for data transfer by a shipment tracking device during transit between an origin location and a destination location. The ping rate is categorized into a transit ping rate and a final portion ping rate, where the final portion ping rate is associated with a final portion of a transit route for the shipment defined by one or more factors (e.g., arrival at a final transit hub, remaining distance to destination location) and the destination location. This final portion of the transit route for the shipment in the supply chain management and transportation planning area is often referred to as the “final mile”. The transit ping rate is associated with an initial portion of the transit route defined by the origin location and the start of the final portion of the transit route. Embodiments of the present invention adjusts the ping rate based on a remaining battery life (i.e., battery percentage), remaining distance to the destination location, an estimated time of arrival (ETA) calculation between a current location of the shipment tracking device and the destination location, and a calculated travel rate. The travel rate is calculated based on a speed of the shipment tracking device, traffic conditions along the transit route, weather conditions along the transit route, and planned events along the transit route. Embodiments of the present invention can utilize two different ping rates, where the transit ping rate is less frequent than the last portion ping rate. However, for each of the transit ping rate and the last portion ping rate, the ping rate is continuously adjusted to ensure the remaining battery life can provide the increased frequency of pings for the last portion of the transit route.

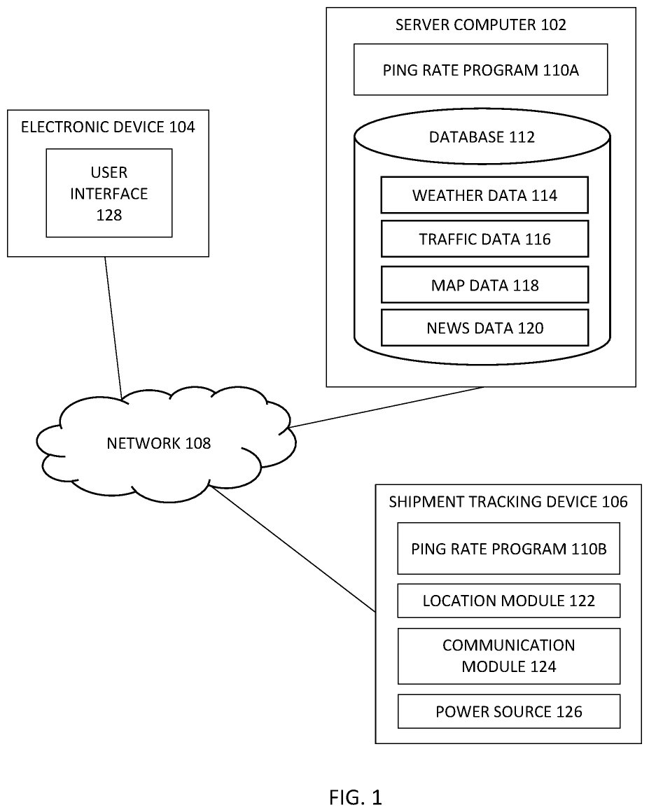

FIG. 1 is a functional block diagram illustrating a distributed data processing environment, in accordance with one embodiment of the present invention. The distributed data processing environment includes server computer 102, electronic device 104, and shipment tracking device 106 all interconnected over network 108. For discussion purposes, ping rate program 110 can operate on server computer 102 as ping rate program 110A or on shipment tracking device 106 as ping rate program 110B.

Server computer 102 may be a desktop computer, a laptop computer, a tablet computer, a specialized computer server, a smartphone, or any computer system capable of executing the various embodiments of ping rate program 110A. In certain embodiments, server computer 102 represents a computer system utilizing clustered computers and components that act as a single pool of seamless resources when accessed through network 108, as is common in data centers and with cloud computing applications. In general, server computer 102 is representative of any programmable electronic device or combination of programmable electronic devices capable of executing machine-readable program instructions and communicating with other computer devices via a network. In this embodiment, server computer 102 has the ability to communicate with other computer devices to query the computer devices for information. Server computer 102 includes ping rate program 110A, database 112, weather data 114, traffic data 116, map data 118, and news data 120. In this embodiment, ping rate program 110A represents a server-side based ping rate program 110.

Electronic device 104 can be a laptop computer, a tablet computer, a smart phone, smart watch, a smart speaker, or any programmable electronic device capable of communicating with various components and devices within distributed data processing environment, via network 108. In general, electronic device 104 represents one or more programmable electronic devices or combination of programmable electronic devices capable of executing machine readable program instructions and communicating with other computing devices (not shown) within distributed data processing environment via a network, such as network 108. In one embodiment, electronic device 104 represents one or more devices associated with a user (e.g., owner of shipment tracking device 106). Electronic device 104 includes an instance of user interface 128.

Shipment tracking device 106 represents an electronic device (e.g., IoT device) associated with a shipment being transported between an origin location and a destination location. Shipment tracking device 106 can provide various data to ping rate program 110A, via ping rate program 110B, including but not limited to shock, vibrations degree of tilt, temperature, light exposure, barometric pressure, moisture, longitudinal and latitudinal shift, and humidity readings. Shipment tracking device 106 provides the various data via a ping, where the ping represents a snapshot of the various data being transfer between shipment tracking device 106 and ping rate program 110A, via ping rate program 110B. Each ping can include the various data discussed above, a unique identifier for a shipment associated with shipment tracking device 106 (e.g., tracking number), a unique identifier for shipment tracking device 106 (e.g., device serial number), a timestamp, and location information. Shipment tracking device 106 include ping rate program 110B, location module 122, communication module 124, power source 126.

Location module 122 allows for shipment tracking device 106 to provide location information of the shipment with every ping of data to ping rate program 110A. Location module 122 can utilize Global Positioning System (GPS) and/or cellular triangulation to determine a location of shipment tracking device 106 and ping rate program 110B operating on shipment tracking device 106 can send the location information to ping rate program 110A operating on server computer 102. The location information can include one or more of: GPS coordinates, a town/city, a county, a state, a region, a providence, and a country for each ping of the various data that shipment tracking device 106 sends to ping rate program 110A. Communication module 124 allows for ping rate program 110B on shipment tracking device 106 to communicate with ping rate program 110A on server computer 102, via network 108. Power source 126 represents one or more battery packs associated with shipment tracking device 106, where the one or more battery packs are rechargeable and/or replaceable. Thus, allowing for shipment tracking device 106 to be reusable and utilized for multiple subsequent shipments.

In general, network 108 can be any combination of connections and protocols that will support communications between server computer 102, electronic device 104, and shipment tracking device 106. Network 108 can include, for example, a local area network (LAN), a wide area network (WAN), such as the internet, a cellular network, or any combination of the preceding, and can further include wired, wireless, and/or fiber optic connections. In one embodiment, ping rate program 110A can be a web service accessible via network 108 to a user of electronic device 104. In another embodiment, ping rate program 110A may be operated directly by a user of server computer 102.

Ping rate program 110 manages a ping rate for data transfer by shipment tracking device 106 during transit between an origin location and a destination location. Ping rate program 110 receives shipment information and activates shipment tracking device 106 for monitoring and tracking the shipment during transit, where shipment tracking device 106 determines an available battery life for power source 126. Ping rate program 110 determines a budget of pings for data transfer between the origin location and the destination location based on the determined available battery life for power source 126 of shipment tracking device 106. Ping rate program 110 determines a transit ping rate (e.g., every two hours) for data transfer by shipment tracking device 106 based on the determined available battery life and the budget of pings for data transfer, along with weather data 114, traffic data 116, map data 118, and news data 120. Weather data 114 includes weather conditions along an expected route for the shipment between the origin location and the destination location. Weather condition information can include wind speeds, type of precipitation, precipitation rates, humidity levels, dew point temperature, ambient temperature, visibility distances, and any type of weather information that can have an adverse effect on the transit time of the shipment. Traffic data 116 can include road surface condition (e.g., potholes, ice), traffic delays, accident occurrences, roadway debris (e.g., fallen tree), disabled vehicles, road works, and any type of transport and road related information that can have an adverse effect on the transit time of the shipment. Map data 118 can include satellite imagery, aerial photography, street maps for all vehicle, street maps for transport trucks, and or any other type of available mapping data to identify a location for each ping sent by shipment tracking device 106. News data 120 can include warnings (e.g., winter storm warning or tornado warning) issued by an agency, such as the National Weather Service (NWS), relating to extreme or hazardous related weather events and public event information that can potentially have an adverse effect on the transit time of the shipment. Ping rate program 110 can source weather data 114, traffic data 116, map data 118, and news data 120 from freely available services or accessible via a subscription-based service.

Subsequently, ping rate program 110 receives a ping with data from shipment tracking device 106 at an interval defined by the transit ping rate and determines a remaining battery life for power source 126. Responsive to ping rate program 110 determining shipment tracking device 106 has not reached a final portion of the transit route, ping rate program 110 reverts back to determining a budget of remaining pings for data transfer. Responsive to ping rate program 110 determining shipment tracking device 106 has reached the final portion of the transit route, ping rate program 110 determines a final portion ping rate (e.g., every 15 minutes) based on the remaining battery life for power source 126, along with along with weather data 114, traffic data 116, map data 118, and news data 120. Ping rate program 110 receives a ping with data from shipment tracking device 106 at an interval defined by the final portion ping rate. Responsive to ping rate program 110 determining the shipment was not delivered, ping rate program 110 reverts back to determining a remaining battery life for power source 126. Responsive to ping rate program 110 determining the shipment was delivered, ping rate program 110 terminates the shipment and instructs shipment tracking device 106 to power off.

Database 112 is a repository for data used by ping rate program 110. In the depicted embodiment, database 112 resides on server computer 102. In another embodiment, database 112 may reside on electronic device 104 or elsewhere within distributed the data processing environment provided ping rate program 110 has access to database 112. Database 112 can be implemented with any type of storage device capable of storing data and configuration files that can be accessed and utilized by ping rate program 110, such as a database server, a hard disk drive, or a flash memory. As previously mentioned, database 112 stores data utilized by ping rate program 110, such as weather data 114, traffic data 116, map data 118, and news data 120.

User interface 128 enables a user to make requests of or issue commands to electronic device 104 and receive information and instructions in response. In one embodiment, a user of electronic device 104 accesses user interface 128 via voice commands in natural language. In one embodiment, user interface 128 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. In another embodiment, user interface 128 may also be mobile application software. In an example, mobile application software, or an “app,” is a computer program designed to run on smart phones, tablet computers and other mobile devices. User interface 128 enables a user of electronic device 104 to interact with ping rate program 110.

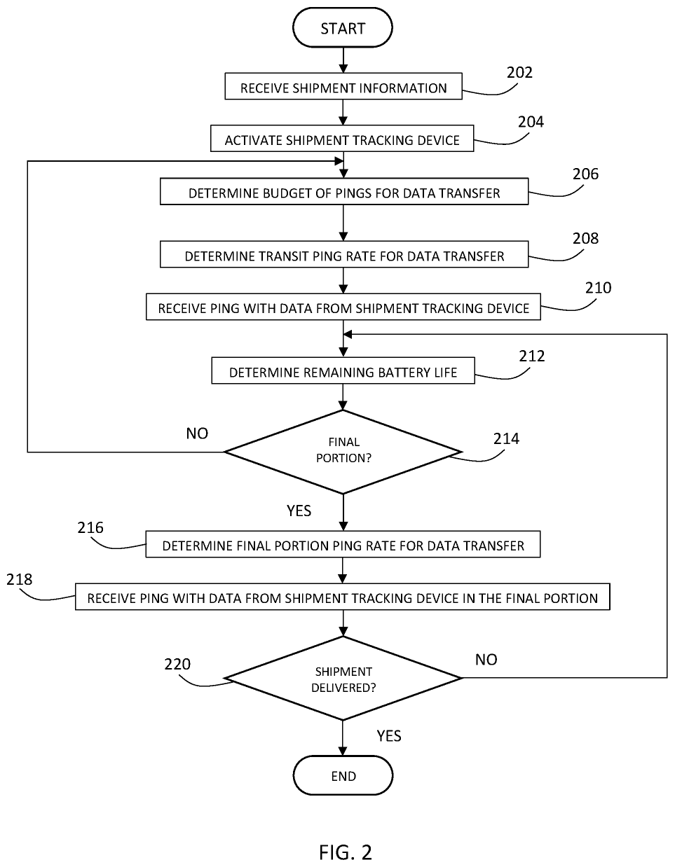

FIG. 2 is a flowchart depicting operational steps of a ping rate program for managing a transit ping rate of a shipment tracking device, in accordance with an embodiment of the present invention.

Ping rate program 110 receives shipment information (202). Ping rate program 110 receives shipment information that defines an origin location and a destination location for a shipment, where the shipment includes an associated shipment tracking device for providing various data along a route between the origin location and the destination location. The shipment information can include but is not limited to, an origin location, a destination location, carrier information, an airway bill (AWB), a unique identifier for the shipment (e.g., tracking number), and a unique identifier for the shipment tracking device (e.g., device serial number). Ping rate program 110 associates the unique identifier for the shipment with the unique identifier for the shipment tracking device. The shipment tracking device is reusable and upon arrival at the destination location, the shipment tracking device is associated with a subsequent another unique identifier for another shipment. However, since the power source on the shipment tracking device is limited, the power source would have to be recharged and/or replaced with the subsequent shipment.

Ping rate program 110 activates a shipment tracking device (204). Subsequent to the association of the unique identifier for the shipment with the unique identifier for the shipment tracking device, ping rate program 110 instructs the associated shipment tracking device to activate. The activation of the shipment tracking device includes a calibration of the various data to ensure the various data collected by the shipment tracking device is accurate. The various data the shipment tracking device collects includes but is not limited to shock, vibrations degree of tilt, temperature, light exposure, barometric pressure, moisture, longitudinal and latitudinal shift, and humidity readings. The shipment tracking device can also provide location information for very instance (i.e., ping) of the various data collected, where each ping includes the various data discussed above, the unique identifier for the shipment associated with shipment tracking device, the unique identifier for shipment tracking device, a timestamp, and the location information. Ping rate program 110 also determines a remaining battery life for a power source the shipment tracking device with a known battery capacity, where the power source includes a full charge prior to an initialization of the shipment between the origin location and the destination location.

Ping rate program 110 determines a budget of pings for data transfer (206). Based on the determined remaining battery life for the power source of the shipment tracking device, ping rate program 110 determines the budget of pings for data transfer from the shipment tracking device to ping rate program 110 during the transit between the origin location and the destination location. Ping rate program 110 can also utilize manufacture information for multiple sensors (e.g., temperature sensor, accelerometer, location module) associated with the shipment tracking device for collecting the various data, to determine how much energy of the power source is utilized to collect the various data for every ping. Ping rate program 110 allows the user to define which of the data is collected during the transit of the shipment (e.g., temperature and humidity) and which of the data is not to be collected (e.g., tilt and light), to conserve energy of the power source with every ping of data transfer. Furthermore, ping rate program 110 has the ability to adjust during transit which of the data is collected for the shipment and which of the data is not to collected for the shipment, at certain points along the route between the origin location and the destination location.

Ping rate program 110 determines a transit ping rate for the data transfer (208). As previously discussed, a transit route for a shipment between an origin location and a destination location is defined by an initial portion and a final portion. Ping rate program 110 utilizes a transit ping rate for the initial portion of the transit route and a final portion ping rate for the final portion of the transit route, where the final portion of the transit route for the shipment in the supply chain management and transportation planning area is often referred to as the “final mile”. The final portion of the transit route for the shipment is defined by one or more factors (e.g., arrival at a final transit hub, remaining distance to destination location) and the destination location. The initial portion of the transit route for the shipment is define by the origin location and the start of the final portion of the transit route for the shipment as defined by the one or more factors. In one embodiment, a final portion of the transit route starts with an arrival at a final transit hub from which a local delivery truck is to deliver the shipment to the destination location. In another embodiment, a final portion of the transit route starts when a remaining distance to the destination location is within a radius of 5 miles. In yet another embodiment, a final portion of the transit route starts when an expected delivery time at the destination location is within 12 hours.

Ping rate program 110 determines the transit ping rate based on the determined available battery life for the power source of the shipment tracking device and the determined budget of pings for data transfer. Furthermore, ping rate program 110 has the ability to determine the transit ping rate based on one or more of: weather data, traffic data, map data, and news data. For the determined available battery life, ping rate program 110 identifies a portion of the determined available battery life to allocate for the initial portion of the transit route and identifies another portion of the determined available battery life to allocate for the final portion of the transit route, where the other portion of the determined available battery life takes into the account an increased ping rate (i.e., decreased interval) for the final portion of the transit route. For the determined budget of pings for data transfer, ping rate program 110 identifies a portion of the determined budget of pings for data transfer to allocate for the initial portion of the transit route and identifies another portion of the determined budget of pings to allocate for the final portion of the transit route. For weather data, ping rate program 110 determines weather conditions along the transit route and can increase the transit ping rate for instances of severe weather (e.g., thunderstorm, snowstorm, heatwave) and decrease the transit ping rate for instances of non-severe weather. Thus, ensuring ping rate program 110 receives the various data from the shipment tracking device more frequently for the severe weather conditions, where the shipment can potentially experience shock, high heat, and freezing temperatures due to the severe weather conditions.

For traffic data, ping rate program 110 determines traffic conditions along the transit route based on reported accidents, roadworks, street closures, and/or traffic camera footage. Ping rate program 110 can decrease the transit ping rate for instances of high traffic, where the available battery life of the power source is to be persevered to ensure the battery life remains for the final portion of the transit route. For map data, ping rate program 110 determines the various routes a transporter utilizes along the transit route and can increase or decrease the transit ping rate if the transporter takes a direct route or an indirect route with detours, respectively. For news data, ping rate program 110 identifies any potential transit route disruptions between the origin location and the destination location based on various news sources and/or social media posts. Ping rate program 110 can decrease the transit ping rate for instances of potential disruptions (e.g., planned parades, street fairs) along the transit route, where the available battery life of the power source is to be persevered to ensure the battery life remains for the final portion of the transit route.

Ping rate program 110 can also determine the transit ping rate based on a mode of transport for the shipment with the shipment tracking device. For example, if the shipment is in transit on an overseas flight, ping rate program 110 decreases the transit ping rate for an expected time interval where the airplane is at cruising altitude, since the conditions onboard the airplane would more than likely remain constant at cruising altitudes. Ping rate program 110 increases the transit ping rate for the expected time interval (e.g., first 30 minutes and last 30 minutes of flight) where the airplane is ascending and descending, since the conditions aboard the airplane would more than likely change (e.g., tilt and pressure) during the ascending and descending maneuvers. Ping rate program 110 can also determine the transit ping rate based on whether the shipment has reached a waypoint (e.g., transit hub, customs hub). Ping rate program 110 increases the transit ping rate if the shipment is located near (e.g., x<one-mile radius) a waypoint and decreases the transit ping rate if the shipment is not located near (e.g., x>one-mile radius) a waypoint, since the shipment is likely to be handled by one or more persons at the waypoint. Subsequent to determining the transit ping rate, ping rate program 110 instructs the shipment tracking device to utilize the determined transit ping rate to collect and send the various data for the shipment.

Ping rate program 110 receives a ping with data from the shipment tracking device (210). Ping rate program 110 receives ping with various data from the shipment tracking device at an interval (e.g., every two hours) defined by the transit ping rate, where the ping includes the unique identifier for the shipment associated with shipment tracking device, the unique identifier for shipment tracking device, a timestamp, and the location information. As previously discussed, the various data the shipment tracking device collects includes but is not limited to shock, vibrations degree of tilt, temperature, light exposure, barometric pressure, moisture, longitudinal and latitudinal shift, and humidity readings. In this embodiment, ping rate program 110 displays the various data from the shipment tracking device in a user interface on an electronic device associated with the user, where the user can view the various data, the unique identifier for the shipment associated with shipment tracking device, the unique identifier for shipment tracking device, the timestamp, and the location information for the received ping. In other embodiments, ping rate program 110 receives and stores the ping with the various data based on the identifier for the shipment associated with shipment tracking device and the unique identifier for shipment tracking device.

Ping rate program 110 determines a remaining battery life (212). Ping rate program 110 determines a remaining battery life for a power source the shipment tracking device with the known battery capacity. Ping rate program 110 can monitor a depletion of battery life for the power source associated with the shipment tracking device for every ping that is received. Ping rate program 110 can compare an expected depletion of battery life for the power source to an actual depletion of battery life for the power to determine if the remaining battery life can sustain the transit ping rate, without affecting an amount of battery life reserved for the final portion of the transit route. In one example, ping rate program 110 previously determined a transit ping rate of two hours, where an expected depletion of battery life for the power source is 0.5% with every ping. However, ping rate program 110 receives a tenth ping from the shipment tracking device and determines a remaining battery life for the power source to be 93% (assuming 100% battery life prior to the first ping), where an actual depletion of battery life for the power source is 0.7% with every ping due to cold temperatures experienced by the shipment tracking device in the transporter. In another example, ping rate program 110 previously determined a transit ping rate of 1.5 hours, where an expected depletion of battery life for the power source is 0.6% with every ping. However, ping rate program 110 receives twentieth ping from the shipment tracking device and determines a remaining battery life for the power source to be 92% (assuming 100% battery life prior to the first ping), where an actual depletion of battery life for the power source is 0.4% with very ping. Ping rate program 110 utilizes this comparison to subsequently determine a remaining budget of pings for data transfer and to update the transit ping rate for data transfer accordingly by increasing, decreasing, or leaving the interval unaltered.

Ping rate program 110 determines whether the shipment tracking device is located in a final portion of the transit route (decision 214). In one embodiment, a final portion of the transit route is defined by an arrival at a final transit hub from which a local delivery truck is to deliver the shipment to the destination location. Ping rate program 110 can utilize the location information from the previously received ping and/or tracking information provided by the carrier via the unique identifier for the shipment associated with shipment tracking device, to determine whether the shipment has arrived at the final hub. In another embodiment, a final portion of the transit route starts when a remaining distance to the destination location is within a predetermined radius of the destination location (e.g., 3 miles). Ping rate program 110 can utilize the location information from the previously received ping and/or tracking information provided by the carrier via the unique identifier for the shipment associated with shipment tracking device, to determine whether the shipment has breached the predetermined radius. In yet another embodiment, a final portion of the transit route starts when an expected delivery time at the destination location is within a predetermined amount of time (e.g., 2 hours). Ping rate program 110 can utilize the location information from the previously received ping and/or tracking information provided by the carrier via the unique identifier for the shipment associated with shipment tracking device, to determine whether the expected delivery time at the destination location is within the predetermined amount of time.

In the event, ping rate program 110 determines the shipment tracking device is located in the final portion of the transit route (“yes” branch, decision 214), ping rate program 110 determines a final portion ping rate for the data transfer (216). In the event, ping rate program 110 determines the shipment tracking device is not located in the final portion of the transit route (“no” branch, decision 214), ping rate program 110 reverts back to determine the transit ping rate for the data transfer (208). By reverting back to determine the transit ping rate for data transfer, ping rate program 110 determines a remaining budget of pings for data transfer and updates the transit ping rate for data transfer accordingly by increasing, decreasing, or leaving the interval unaltered.

Ping rate program 110 determines a final portion ping rate for the data transfer (216). Similar to the transit ping rate, ping rate program 110 determines the final ping rate based on the determined remaining battery life for the power source of the shipment tracking device and the determined budget of pings for data transfer. Furthermore, ping rate program 110 has the ability to determine the transit ping rate based on one or more of: weather data, traffic data, map data, and news data. Since the shipment is located in the final portion of the transit route, ping rate program 110 increases the frequency of ping by decreasing the interval (e.g., every 15 minutes versus every two hours) between each ping by the shipment tracking device. The increased frequency of the final portion ping rate reduces the chances of missing the various data from the shipment tracking device during the delivery (i.e., handover) of the shipment to the recipient by the carrier.

Ping rate program 110 receives a ping with data from the shipment tracking device in the final portion (218). Ping rate program 110 receives ping with various data from the shipment tracking device at an interval (e.g., every 15 minutes) defined by the final portion ping rate. Similar to the ping receives at the transit ping rate, ping rate program 110 can display the various data from the shipment tracking device in a user interface on an electronic device associated with the user, where the user can view the various data, the unique identifier for the shipment associated with shipment tracking device, the unique identifier for shipment tracking device, the timestamp, and the location information for the received ping. Ping rate program 110 can also receive and store the ping with the various data based on the identifier for the shipment associated with shipment tracking device and the unique identifier for shipment tracking device.

Ping rate program 110 determines whether the shipment was delivered at the destination location (decision 220). In the event, ping rate program 110 determines the shipment was not delivered (“no” branch, decision 220), ping rate program 110 reverts back and determines a remaining battery life (212). Ping rate program 110 determines the remaining battery life and subsequently, determine whether the shipment tracking device is still in the final portion of the transit route or whether the shipment tracking device has ventured outside of the final portion of the transit route. In the event, ping rate program 110 determines the shipment was delivered (“yes” branch, decision 220), ping rate program 110 terminates the shipment and instructs the shipment tracking device to power off.

In summary, embodiments of the present invention allow for the dynamic adjustment of a transit ping rate and a last portion ping rate based on a battery life percentage of a power source, a distance to a destination location, and a travel rate provided by weather data, traffic data, map data, and news data. The transit ping rate and the last portion ping rate are continuously adjusted to maximize the battery life of the power source, while ensuring the battery life of the power source does not become fully depleted prior to delivery at the destination location. The last portion ping rate is greater than the transit ping rate, to ensure various data collected by the shipment tracking device is not missed during the final mile of the shipment. Ping rate program 110 applies the transit ping rate and the last portion ping rate on the shipment tracking devices itself, over the cloud via a server computer connected to a network, or a combination of both.

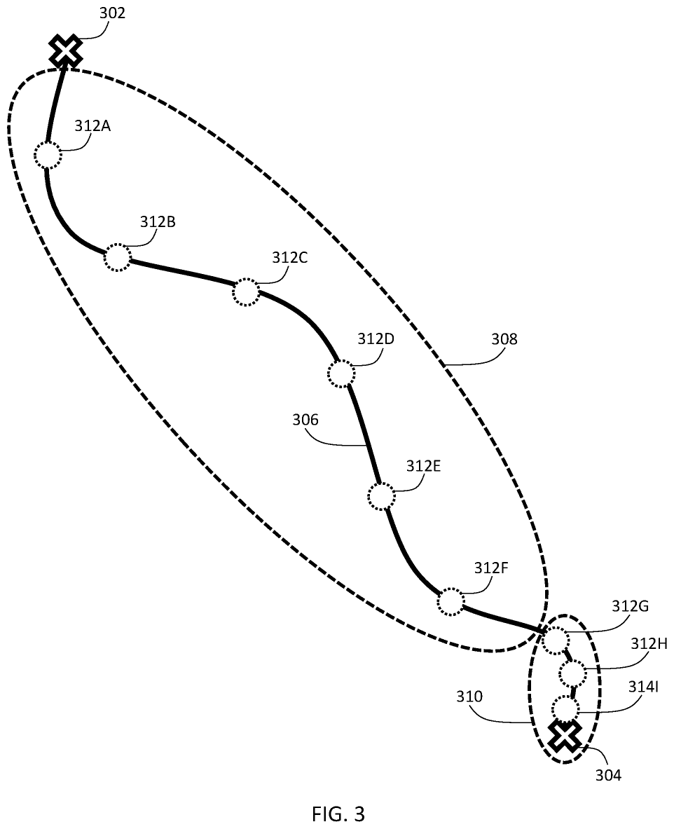

FIG. 3 illustrates an example of a ping rate program managing a transit ping rate and a last portion ping rate of a shipment tracking device traveling between an origin location and a destination location, in accordance with an embodiment of the present invention.

In this example, a shipment with an associated shipment tracking device is traveling from origin location 302 to destination location 304 along transit route 306. Transit route 306 is defined by initial portion 308 and final portion 310, where ping rate program 110 utilizes an initial ping rate for initial portion 308 and a final portion ping rate for final portion 310. Pings 312A, 312B, 312C, 312D, 312D, and 312E within initial portion 308 of transit route 306 represent instances where ping rate program 110 received various data from the shipment tracking device at intervals defined by the initial ping rate. Pings 312G, 312H, and 312I within final portion 310 of transit route 306 represent instances where ping rate program 110 received various data from the shipment tracking device at intervals defined by the final portion ping rate. The final portion ping rate is greater than the initial ping rate to ensure ping rate program 110 receives the various data from the shipment tracking device more frequently in final portion 310 compared to initial portion 308. In this example, assuming constant speed by a transporter associated with a carrier delivering the shipment, a distance traveled between pings in initial portion 308 is greater than a distance traveled between pings in final portion 310.

As ping rate program 110 receives the various data from the shipment tracking device with ping 312A, ping rate program 110 updates the initial ping rate accordingly to ensure there is enough battery life remaining for the power source to continue sending pings up until delivery at destination location 304. Ping rate program 110 repeats this process for all subsequent pings 312B-312F in initial portion 308. As ping rate program 110 receives the various data from the shipment tracking device with ping 312G, ping rate program 110 determines the shipment tracking device is located in final portion 310 and determines to utilize the initial ping rate for subsequent ping 312H. As ping rate program 110 receives the various data from the shipment tracking device with ping 312H, ping rate program 110 updates the final ping rate accordingly to ensure there is enough battery life remaining for the power source to continue sending pings up until delivery at destination location 304. Ping rate program 110 repeats this process until the shipment is delivered at destination location 304.

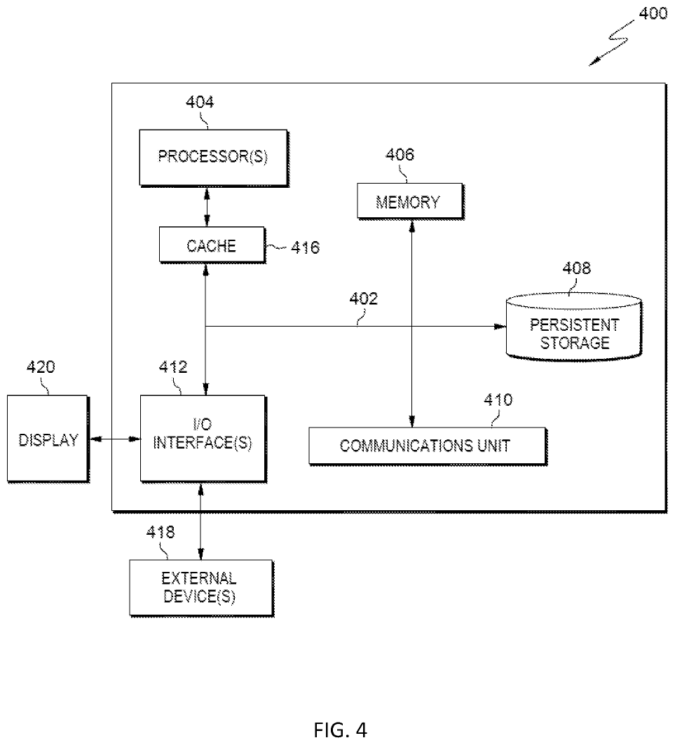

FIG. 4 depicts computer system 400, where server computer 102 and shipment tracking device 106 are examples of a computer system 400 that includes ping rate program 110A and 110B, respectively. The computer system includes processors 404, cache 416, memory 406, persistent storage 408, communications unit 410, input/output (I/O) interface(s) 412 and communications fabric 402. Communications fabric 402 provides communications between cache 416, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses or a crossbar switch.

Memory 406 and persistent storage 408 are computer readable storage media. In this embodiment, memory 406 includes random access memory (RAM). In general, memory 406 can include any suitable volatile or non-volatile computer readable storage media. Cache 416 is a fast memory that enhances the performance of processors 404 by holding recently accessed data, and data near recently accessed data, from memory 406.

Program instructions and data used to practice embodiments of the present invention may be stored in persistent storage 408 and in memory 406 for execution by one or more of the respective processors 404 via cache 416. In an embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices. In these examples, communications unit 410 includes one or more network interface cards. Communications unit 410 may provide communications through the use of either or both physical and wireless communications links. Program instructions and data used to practice embodiments of the present invention may be downloaded to persistent storage 408 through communications unit 410.

I/O interface(s) 412 allows for input and output of data with other devices that may be connected to each computer system. For example, I/O interface 412 may provide a connection to external devices 418 such as a keyboard, keypad, a touch screen, and/or some other suitable input device. External devices 418 can also include portable computer readable storage media such as, for example, thumb drives, portable optical or magnetic disks, and memory cards. Software and data used to practice embodiments of the present invention can be stored on such portable computer readable storage media and can be loaded onto persistent storage 408 via I/O interface(s) 412. I/O interface(s) 412 also connect to display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

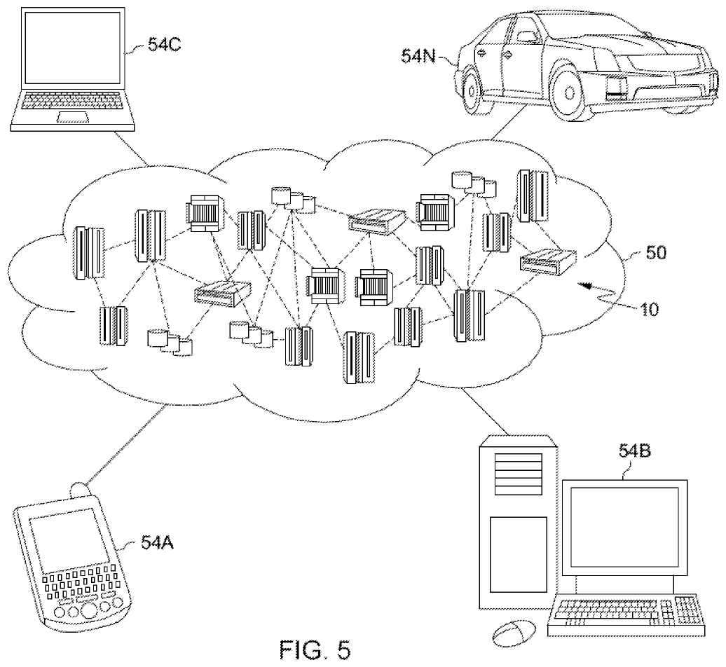

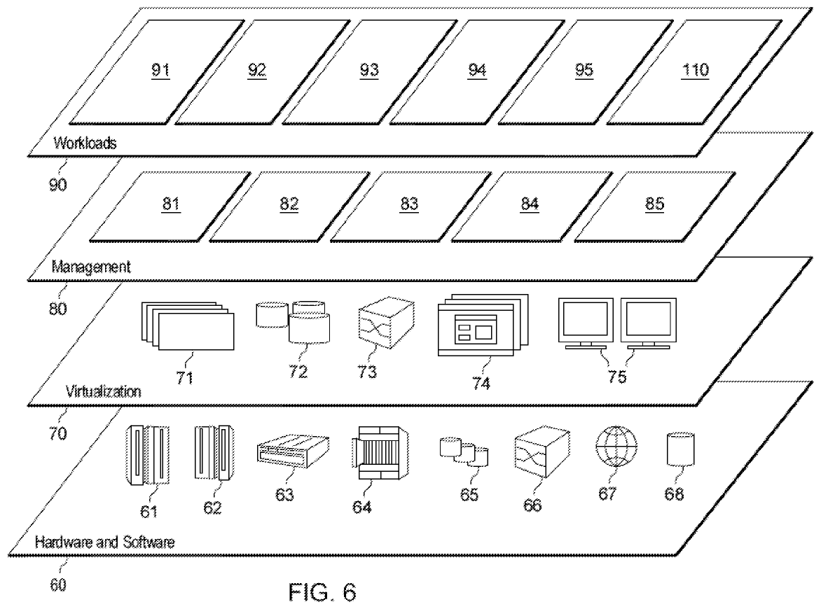

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 include hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and ping rate program 110.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
determining, by one or more processors, a battery life for a power source of a shipment tracking device associated with a shipment;
determining, by the one or more processors, a budget of pings for data transfer by the shipment tracking device, wherein a ping includes various data collected by a plurality of sensors on the shipment tracking device;
determining, by the one or more processors, based on the battery life for the power source and the budget of pings for the data transfer, a transit ping rate for an initial portion of a transit route; and
responsive to receiving a first ping from the shipment tracking device with a first set of the various data, updating, by the one or more processors, the transit ping rate based on the first ping with the first set of data.

2. The method of claim 1, further comprising:
receiving, by the one or more processors, a second ping from the shipment tracking device with a second set of the various data at an interval defined by the transit ping rate.

3. The method of claim 2, further comprising:
determining, by the one or more processors, the transit ping rate based on weather data, traffic data, map data, and news data.

4. The method of claim 1, further comprising:
responsive to determining the shipment tracking device is located in a final portion of the transit route, determining, by the one or more processors, based on a remaining battery life for the power source and the budget of pings for the data transfer, a final portion ping rate for the final portion of the transit route, where the final portion ping rate is g greater than the transit ping rate.

5. The method of claim 4, further comprising:
responsive to receiving a second ping from the shipment tracking device with a second set of the various data, determining, by the one or more processors, based on second ping with the second set of the various data, whether the shipment was delivered at a destination location; and
responsive to determining the shipment was not delivered at the destination location, updating, by the one or more processors, the final portion ping rate based on the second ping with the second set of the various data.

6. The method of claim 5, further comprising:
receiving, by the one or more processors, a third ping from the shipment tracking device with a third set of the various data at an interval defined by the final portion ping rate.

7. The method of claim 6, further comprising:
determining, by the one or more processors, the final portion ping rate based on weather data, traffic data, map data, and news data.

8. A computer program product comprising:
one or more computer readable storage media and program instructions stored on at least one of the one or more storage media, the program instructions comprising:
program instructions to determine a battery life for a power source of a shipment tracking device associated with a shipment;
program instructions to determine a budget of pings for data transfer by the shipment tracking device, wherein a ping includes various data collected by a plurality of sensors on the shipment tracking device;
program instructions to determine, based on the battery life for the power source and the budget of pings for the data transfer, a transit ping rate for an initial portion of a transit route; and
program instructions to, responsive to receiving a first ping from the shipment tracking device with a first set of the various data, update, the transit ping rate based on the first ping with the first set of data.

9. The computer program product of claim 8, further comprising program instructions, stored on the one or more computer readable storage media, which when executed by a processor, cause the processor to:
receive a second ping from the shipment tracking device with a second set of the various data at an interval defined by the transit ping rate.

10. The computer program product of claim 9, further comprising program instructions, stored on the one or more computer readable storage media, which when executed by a processor, cause the processor to:
determine the transit ping rate based on weather data, traffic data, map data, and news data.

11. The computer program product of claim 8, further comprising program instructions, stored on the one or more computer readable storage media, which when executed by a processor, cause the processor to:
responsive to determining the shipment tracking device is located in a final portion of the transit route, determine, based on a remaining battery life for the power source and the budget of pings for the data transfer, a final portion ping rate for the final portion of the transit route, where the final portion ping rate is g greater than the transit ping rate.

12. The computer program product of claim 11, further comprising program instructions, stored on the one or more computer readable storage media, which when executed by a processor, cause the processor to:
responsive to receiving a second ping from the shipment tracking device with a second set of the various data, determine, based on second ping with the second set of the various data, whether the shipment was delivered at a destination location; and
responsive to determining the shipment was not delivered at the destination location, update the final portion ping rate based on the second ping with the second set of the various data.

13. The computer program product of claim 12, further comprising program instructions, stored on the one or more computer readable storage media, which when executed by a processor, cause the processor to:
receive a third ping from the shipment tracking device with a third set of the various data at an interval defined by the final portion ping rate.

14. The computer program product of claim 13, further comprising program instructions, stored on the one or more computer readable storage media, which when executed by a processor, cause the processor to:
determine the final portion ping rate based on weather data, traffic data, map data, and news data.

15. A computer system comprising:
one or more computer processors;
one or more computer readable storage media; and
program instructions stored on the computer readable storage media for execution by at least one of the one or more computer processors, the program instructions comprising:
program instructions to determine a battery life for a power source of a shipment tracking device associated with a shipment;
program instructions to determine a budget of pings for data transfer by the shipment tracking device, wherein a ping includes various data collected by a plurality of sensors on the shipment tracking device;
program instructions to determine, based on the battery life for the power source and the budget of pings for the data transfer, a transit ping rate for an initial portion of a transit route; and
program instructions to, responsive to receiving a first ping from the shipment tracking device with a first set of the various data, update, the transit ping rate based on the first ping with the first set of data.

16. The computer system of claim 15, further comprising program instructions, stored on the one or more computer readable storage media, which when executed by a processor, cause the processor to:
receive a second ping from the shipment tracking device with a second set of the various data at an interval defined by the transit ping rate.

17. The computer system of claim 16, further comprising program instructions, stored on the one or more computer readable storage media, which when executed by a processor, cause the processor to:
determine the transit ping rate based on weather data, traffic data, map data, and news data.

18. The computer system of claim 15, further comprising program instructions, stored on the one or more computer readable storage media, which when executed by a processor, cause the processor to:
responsive to determining the shipment tracking device is located in a final portion of the transit route, determine, based on a remaining battery life for the power source and the budget of pings for the data transfer, a final portion ping rate for the final portion of the transit route, where the final portion ping rate is g greater than the transit ping rate.

19. The computer system of claim 18, further comprising program instructions, stored on the one or more computer readable storage media, which when executed by a processor, cause the processor to:
responsive to receiving a second ping from the shipment tracking device with a second set of the various data, determine, based on second ping with the second set of the various data, whether the shipment was delivered at a destination location; and
responsive to determining the shipment was not delivered at the destination location, update the final portion ping rate based on the second ping with the second set of the various data.

20. The computer system of claim 19, further comprising program instructions, stored on the one or more computer readable storage media, which when executed by a processor, cause the processor to:
receive a third ping from the shipment tracking device with a third set of the various data at an interval defined by the final portion ping rate.
